(19) United States
(12) Patent Application Publication
(10) Pub. No.: US 2005/0228678 A1
(43) Pub. Date: Oct. 13, 2005

(54) Proactive after point of sale qualified subscription product presentation

(76) Inventors: James A. Howell JR., Georgetown, TX (US); Shannon Christopher Boesch, Austin, TX (US)

Correspondence Address: HAMILTON & TERRILE, LLP, P.O. BOX 203518, AUSTIN, TX, 78720, US

(21) Appl. No.: 10/819,412

(22) Filed: Apr. 7, 2004

(51) Int. Cl. G06F 17/60

(52) U.S. Cl. 705/1; 705/16

(57) ABSTRACT

A system for prequalifying an information handling system which includes a configurator, an after point of sale prequalification module and a prequalification information store module. The configurator configures a system with options selected according to user input. The after point of sale prequalification module obtains prequalification information relating to whether an ordered information handling system corresponds to prequalification criteria. The prequalification information store module stores the prequalification information relating to the ordered information handling system.

### BACKGROUND OF THE INVENTION

1. Field of the Invention

The present invention relates to the field of build to order systems, and more particularly to prequalification of customers for subscription services.

2. Description of the Related Services

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One aspect of ordering information handling systems relates to broadband qualification. It is known to allow a customer when ordering an information handling system to qualify and register for services such as broadband services or wireless services at the point of sale (POS). However, some customers may not wish to go through a full qualification and registration process while ordering and purchasing a new information handling system.

### SUMMARY OF THE INVENTION

In accordance with the present invention, a customer is transparently pre-qualified during the purchase process of the information handling system to identify registration and customization information. This prequalification information is then made available to the customer after receiving the ordered information handling system (i.e., after point of sale (APOS)).

In one embodiment, the information handling system may include an icon which is presented on the desktop of the information handling system to allow a customer to check service availability and register a service after receiving the ordered information handling system. For example, rather than presenting an icon that sets forth “click here to see if you can get broadband,” an icon or link is presented that sets forth “you are qualified for broadband at your shipping address . . . click here to start your fee trial.”

The pre-qualification occurs before the information handling system is manufactured. The prequalification information is provided to customers after the information handling system is provided to the customer. The specific prequalification information is retained through the order process and is either installed on the information handling system for use by an application or may be provided to the delivered information handling system via a link such as an Internet connection.

Because these services are typically location-based, once a shipping location has been determined for a particular system other types of location specific services could be presented to the customer. For example, if a particular location is known to have access to a wireless hotspot such as a T-Mobile wireless hotspot access in a specific city, this information can be relayed to the customer along with information on how to receive a manufacturer specific offer.

In one embodiment, the invention relates to a system for prequalifying an information handling system which includes a configurator, an after point of sale prequalification module and a prequalification information store module. The configurator configures a system with options selected according to user input. The after point of sale prequalification module obtains prequalification information relating to whether an ordered information handling system corresponds to prequalification criteria. The prequalification information store module stores the prequalification information relating to the ordered information handling system.

In another embodiment, the invention relates to a method for prequalifying an information handling system which includes configuring a system with options selected according to user input, obtaining prequalification information relating to whether an ordered information handling system corresponds to prequalification criteria, and storing the prequalification information relating to the ordered information handling system.

In another embodiment, the invention relates to an apparatus for prequalifying an information handling system which includes means for configuring a system with options selected according to user input, means for obtaining prequalification information relating to whether an ordered information handling system corresponds to prequalification criteria, and means for storing the prequalification information relating to the ordered information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a customer accessing a system configuration store.

FIG. 2 shows a system block diagram of an information handling system.

FIG. 3 shows a schematic block diagram of the system configuration store.

FIG. 4 shows a flow chart of the operation of a proactive after point of sale qualified subscription product system.

FIG. 5 shows a flow chart of the operation of another proactive after point of sale qualified subscription product system.

FIG. 6 shows a flow diagram of the configuration of an information handling system to include the customization features.

### DETAILED DESCRIPTION

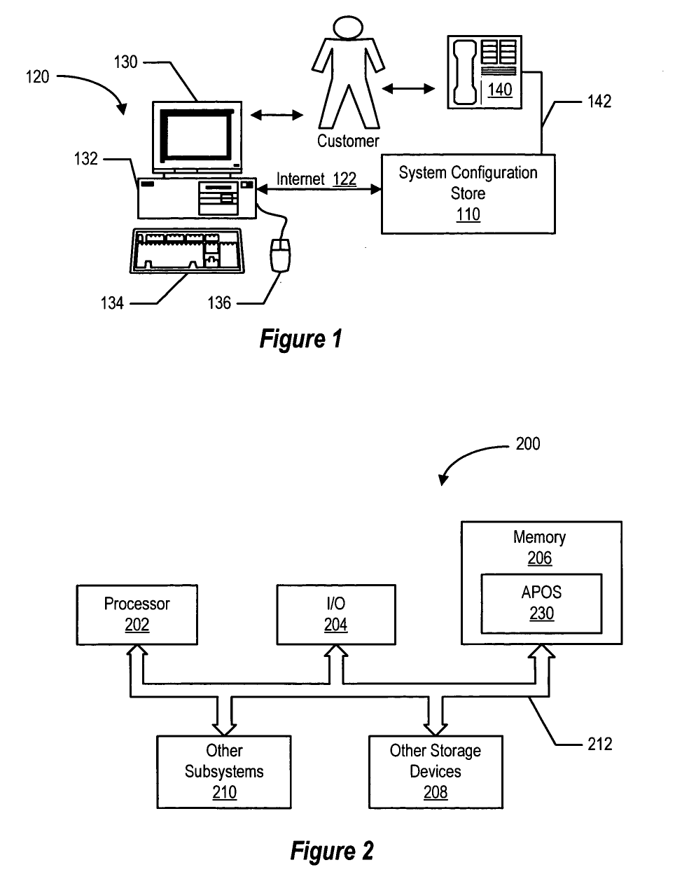

Referring to FIG. 1, a customer can access a system configuration store 110 using any suitable computer equipment 120, via the Internet 122. The computer equipment 120 may include a display 130, computer 132, keyboard 134, and pointing device 136. Display 130 is used for displaying the various pages of the on-line store while a customer is using the on-line store. Alternately, a customer can access the system configuration store 110 via a telephone 140 which is coupled to the system configuration store via a telephone network 142. In the case of a telephone access to the system configuration store, the customer speaks with a sales representative who obtains the configuration information from the customer and in turn enters the information into the system configuration store 110 to configure a system.

Referring to FIG. 2, a system block diagram of an information handling system 200 is shown having features configured in accordance with the system configuration store 110. The information handling system 200 includes a processor 202, input/output (I/O) devices 204, such as a display, a keyboard, a mouse, and associated controllers, memory 206 including volatile memory such as random access memory (RAM) and non-volatile memory such as a hard disk and drive, and other storage devices 208, such as a floppy disk drive, a CD ROM drive and other memory devices, and various other subsystems 210, all interconnected via one or more buses 212.

The information handling system may include after point of sale prequalification information 230 stored within the memory 206.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

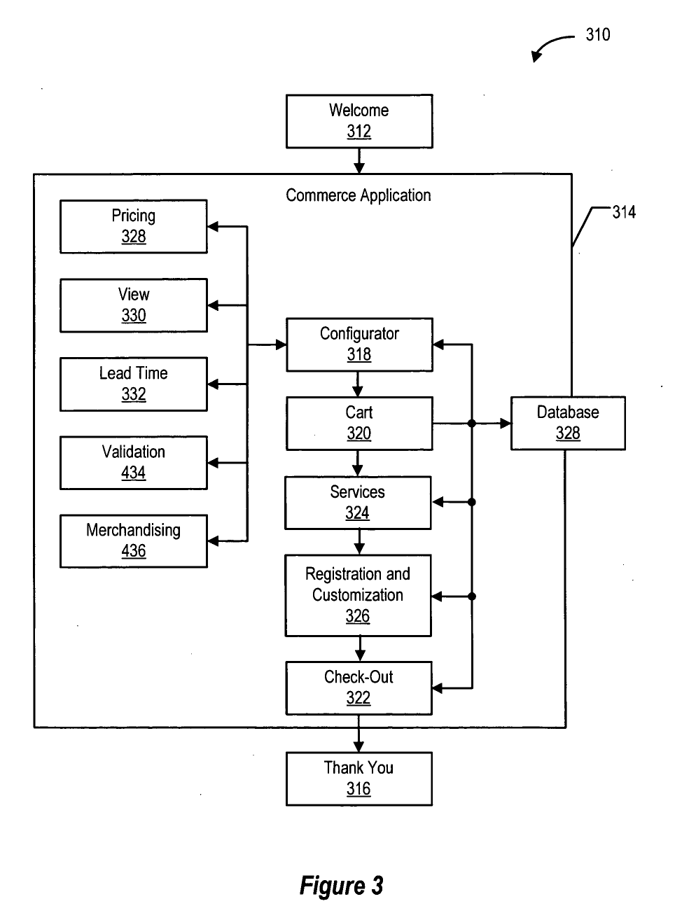

Referring to FIG. 3, an on-line store is a component of an Internet website to which a customer may go to configure a particular information handling system, for example, according to desired options of the customer. An on-line store is one example of a system configuration store 110. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

An on-line store 310 for use in generating customer configured information handling systems, e.g., customer configured computer systems, is shown. The on-line store 310 includes a welcome or introductory module 312, a commerce application module 314, and a thank you module 316. The on-line store 310 includes an on-line store user interface which enables the system configuration, pricing, and ordering of an information handling system via the Internet. The commerce application 314 includes a configurator 318, shopping cart 320, a checkout module 322, a services activation module 324, a registration and customization module 326 and database 328. The database 328 provides information to the configurator 318, shopping cart 320, checkout module 322, services activation module 324 and registration and customization module 326. The configurator 318 includes a pricing module 328, a view module 330, a lead time warning module 332, a validation (or compatibility) warning module 334, and a merchandising module 336. The various modules of the configurator 318 are driven by data from the database 328, and thus the configurator 318, shopping cart 320, checkout module 322 and services activation module 324 are all linked to the database 328.

In operation of the on-line store 310, the welcome module 312 presents a welcome page 312, the configurator 318 presents a configurator page, the shopping cart 320 presents a shopping cart page, the checkout module 322 presents a checkout page, the services activation module 324 presents a services activation page, the registration and customization module 326 provides a registration and customization page and the thank you module 316 presents a thank you page. The welcome page includes a static page and generally resides outside of the commerce application 314. The configurator page, shopping cart page, checkout page, services activation page and registration and customization page are within the commerce application and use information provided by the database. The checkout includes a payment feature, delivery feature, personal versus business feature, and instructional text features (i.e., how to fill out an on-line form.)

The welcome page is typically an introductory page and includes a link into the on-line store 310. The welcome page is typically a static welcome page. Upon completion of configuration of a system, is transferred to a services activation page in which the customer is provided an opportunity to activate various services such as internet service or content services such as music services. After completion of the services activation, the customer is transferred to the registration and customization page. After completion of the registration and customization, the customer is transferred to a checkout page. After completion of the checkout, the customer is transferred to a static thank you page. The thank you page provides a message of gratitude to the customer for having placed the order or for visiting the on-line store.

Aspects of the configurator 318 which interact with database 328 are shown in FIG. 3. In essence, the entire commerce application 314 interacts with the database. The configurator 318, shopping cart 320, checkout module 322, services activation module 324 and registration and customization module are each part of the commerce application 314 and interact with the database 328. For example, with the shopping cart 320, additional merchandising information associated with a particular system which has been configured and placed in the shopping cart by an on-line store customer can be provided.

Also for example, various services may be provided for order by the customer by the services module 324 based upon the type of system ordered as well as components that are included within the system ordered. Additionally, by providing the services module within the commerce application 314, the customer continues the experience a similar customer experience and the system provider is able to use the information from the database 328 and to maintain control over the customer contact. By maintaining control over the customer contact the system provider is able to determine what services are activated and to maintain accurate and up to date records of the service activation. The services module 324 includes a proactive point of sale prequalification module.

When a purchase is processed via the telephone, then the customer representative interacts with a system similar to configurator 318.

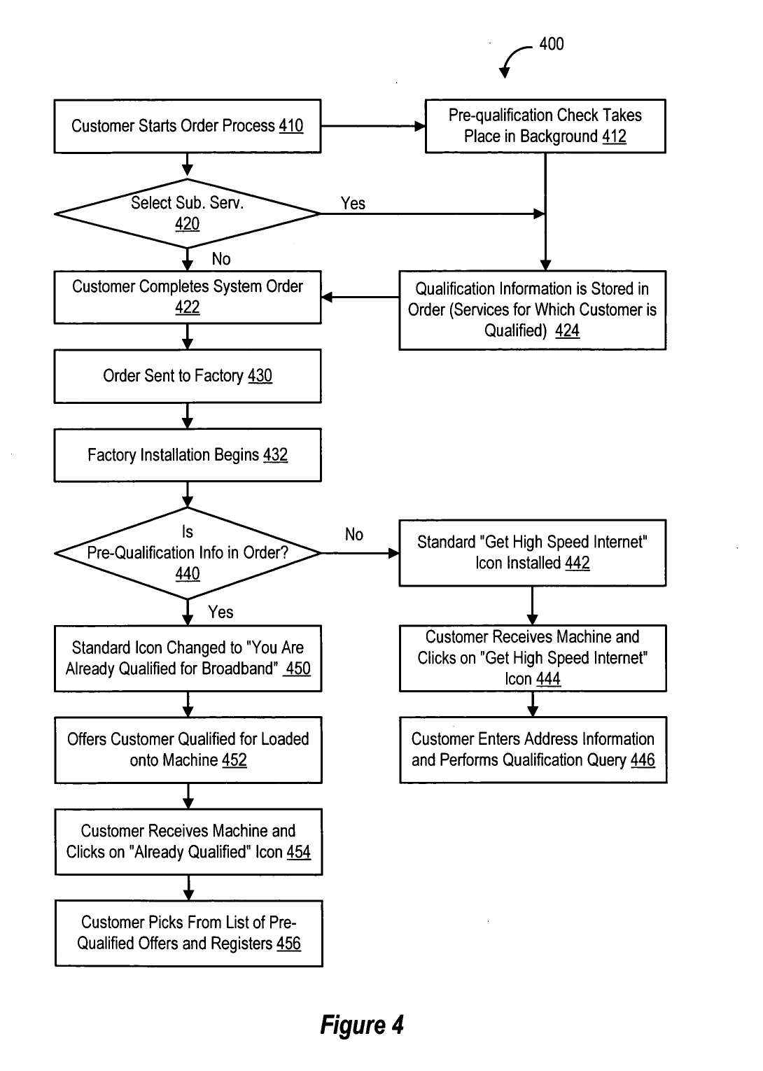

Referring to FIG. 4, a flow chart of the operation of a proactive after point of sale prequalification module 400 is shown. More specifically, when a customer initiates an order process at step 410, the after point of sale prequalification module 400 initiates a broadband prequalification check in the background at step 412. The prequalification check includes electronically contacting service providers, passing address information to the qualification system, and receiving back and presenting the list of available services for that location. Next, the customer may elect not to select a subscription service at step 420. If not, then the customer completes a system order at step 422. The qualification information that was determined at step 412 is then stored and associated with the customer order at step 424. The qualification information indicates for which particular subscription services the customer is qualified.

Next the order is sent to the factory for the information handling system to be manufactured at step 430. During the manufacture, the factory installation of ordered software is initiated at step 432. During the factory installation, the order is reviewed to determine whether there is any prequalification information associated with the order at step 440.

If not, then the factory installation installs a standard high speed internet icon onto the target information handling system at step 442. When the customer receives the information handling system, the customer actuates a “Get High Speed Internet” icon to start the process of activating a general high speed internet account at step 444. The customer then enters address information and provides any information to perform a qualification query for the customer at step 346.

If there is prequalification information associated with the order as determined by step 440, then the system 400 installs a prequalification icon onto the information handing system at step 450. The prequalification icon sets forth information such as “You are already Qualified for Broadband”. Any offers for which the customer is qualified are also installed onto the information handling system. When the customer receives the information handling system, the customer actuates the prequalification icon to start the process of activating a high speed internet account at step 452. The customer then chooses from a list of prequalified offers and registers for the selected offers at step 356.

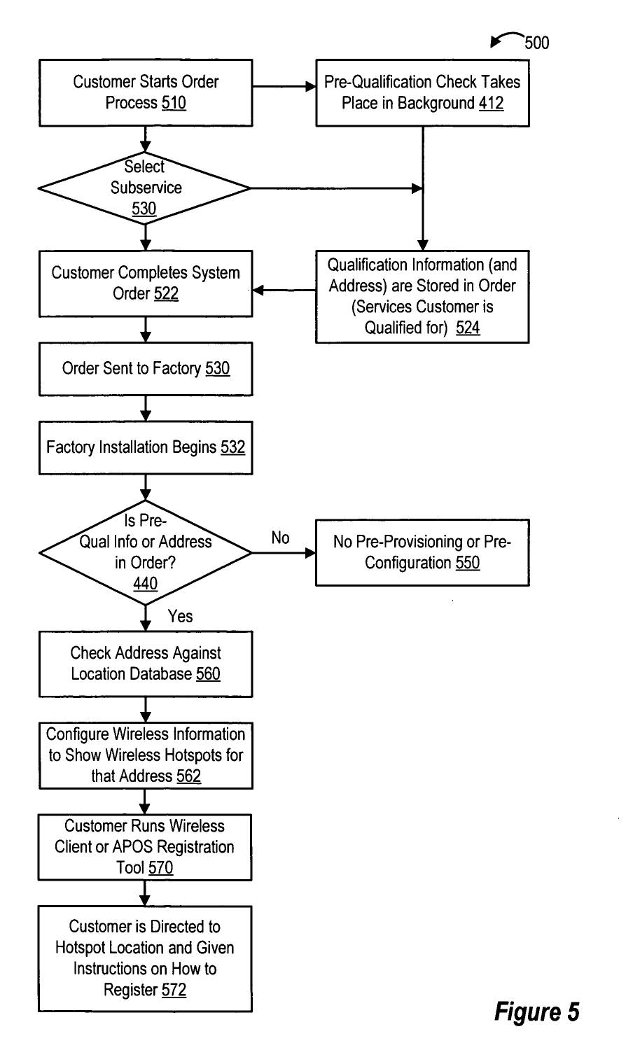

Referring to FIG. 5, a flow chart of the operation of another proactive after point of sale prequalification module 500 is shown. More specifically, when a customer initiates an order process at step 510, the after point of sale prequalification module 500 initiates a wireless hotspot prequalification check in the background at step 412. The prequalification check includes comparing the customer's address against known locations of wireless hotspot services, retrieving the list and presenting the list of available hotspot services for that location. Next, the customer may elect not to select a subscription service at step 520. If not, then the customer completes a system order at step 522. The qualification information that was determined at step 512 is then stored and associated with the customer order at step 524. The qualification information indicates for which particular subscription services the customer is qualified.

Next the order is sent to the factory for the information handling system to be manufactured at step 530. During the manufacture, the factory installation of ordered software is initiated at step 532. During the factory installation, the order is reviewed to determine whether there is any prequalification information associated with the order at step 540.

If not, then the factory installation no pre-provisioning or pre-configuration is performed on the information handling system at step 550.

If there is prequalification information associated with the order as determined by step 540, then the system 500 checks the address to which the information handling system is to be shipped against wireless hotspot location database at step 560. The information handling system is then configured with wireless information to show wireless hotspots for the address at step 562.

When the custom receives the information handling system, the customer may execute a wireless client or an after point of sale registration tool at step 570. When executing this tool, the customer is directed to a wireless hotspot location and provided with instructions of how to register at step 572.

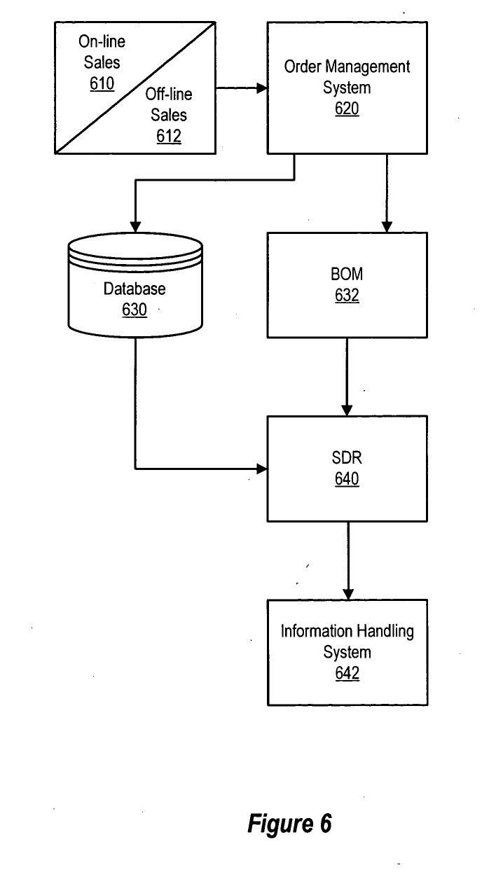

Referring to FIG. 6, when registration or customization information is obtained either via on-line sales 610 or via off-line (e.g., telephone) sales 612, the information is provided to an order management system 620 which interacts with the factory in which the system is manufactured. The order management system 620 stores this information to a database 630 as well as to a Bill of Materials (BOM) 632 which is associated with a particular system being manufactured. It will be appreciated that one or both the database 630 or the BOM 632 may be used to transfer the information from the customer order to a particular information handling system. The information is then stored in a system descriptor record (SDR) which is stored on the memory of the information handling system 642 being manufactured. Accordingly, the registration or customization information that is obtained from the customer is stored on the system that is manufactured for that customer.

Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, it will be appreciated that the order in which the customer is presented with the services activation page, the registration and customization page and check out page may vary. E.g., the customer may checkout before accessing the services activation page. Alternately, the services activation module may not be presented at all.

Also for example, the wireless hotspot prequalification process could be enhanced to determine travel locations for a particular customer. Upon such a determination, the system 500 could also install wireless hotspot prequalification information to enable the customer to register the information handling system to wireless hotspots which are located close to travel destinations. The system could also include information, such as e.g., maps, to ease finding the locations.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A system for prequalifying an information handling system comprising:
a configurator, the configurator configuring a system with options selected according to user input;
an after point of sale prequalification module, after point of sale prequalification module obtaining prequalification information relating to whether an ordered information handling system corresponds to prequalification criteria;
a prequalification information store module, the prequalification information store module storing the prequalification information relating to the ordered information handling system.

2. The system of claim 1 wherein:
the prequalification information is pre-loaded onto the ordered information handling system when the information handling system is fabricated.

3. The system of claim 1 wherein
the prequalification information relates to broadband registration.

4. The system of claim 1 wherein
the prequalification information relates to wireless hotspot registration.

5. The system of claim 1 further comprising
a service activation module, the service activation module enabling a user to activate services based upon the prequalification information.

6. The system of claim 1 wherein
the prequalification information is obtained on-line.

7. The system of claim 1 wherein
the prequalification registration information is obtained via the telephone.

8. A method for prequalifying an information handling system comprising:
configuring a system with options selected according to user input;
obtaining prequalification information relating to whether an ordered information handling system corresponds to prequalification criteria;
storing the prequalification information relating to the ordered information handling system.

9. The method of claim 8 wherein:
the prequalification information is pre-loaded onto the ordered information handling system when the information handling system is fabricated.

10. The method of claim 8 wherein
the prequalification information relates to broadband registration.

11. The method of claim 8 wherein
the prequalification information relates to wireless hotspot registration.

12. The method of claim 8 further comprising
enabling a user to activate services based upon the prequalification information.

13. The method of claim 1 wherein
the prequalification information is obtained on-line.

14. The method of claim 8 wherein
the prequalification registration information is obtained via the telephone.

15. A apparatus for prequalifying an information handling system comprising:
means for configuring a system with options selected according to user input;
means for obtaining prequalification information relating to whether an ordered information handling system corresponds to prequalification criteria;
means for storing the prequalification information relating to the ordered information handling system.

16. The apparatus of claim 15 wherein:
the prequalification information is pre-loaded onto the ordered information handling system when the information handling system is fabricated.

17. The apparatus of claim 15 wherein
the prequalification information relates to broadband registration.

18. The apparatus of claim 15 wherein
the prequalification information relates to wireless hotspot registration.

19. The apparatus of claim 15 further comprising
means for enabling a user to activate services based upon the prequalification information.

20. The apparatus of claim 15 wherein
the prequalification information is obtained on-line.

21. The apparatus of claim 15 wherein
the prequalification registration information is obtained via the telephone.
